(19) United States
(12) Patent Application Publication
(10) Pub. No.: US 2025/0074821 A1
(43) Pub. Date: Mar. 6, 2025

(54) METHODS OF PRODUCING REFRACTORY BRICK

(71) Applicant: Saudi Arabian Oil Company, Dhahran (SA)

(72) Inventors: Mansour Al-Shafei, Saihat (SA); Fatimah Edhaim, Al Qatif (SA); Ahmed Al-Asseel, Al Qatif (SA); Akram Alfliow, Al Sheraa (SA)

(21) Appl. No.: 18/460,293

(22) Filed: Sep. 1, 2023

(51) Int. Cl. C04B 18/04; C04B 18/167; C04B 20/02; C04B 20/04; C04B 28/04; C04B 40/00

(52) U.S. Cl. CPC C04B 18/0481; C04B 18/167; C04B 20/026; C04B 20/04; C04B 28/04; C04B 40/0042; B28B 1/14; C04B 2111/28; C04B 2201/50

(57) ABSTRACT

A method of producing refractory brick includes heating a spent Claus catalyst, reducing a particle size of the catalyst, dry mixing the catalyst with cement to form a dry mixture, adding water to the dry mixture to form a castable mixture, casting the castable mixture in a mold, curing the mold, and drying the mold to form the refractory brick.

### FIELD

The disclosure relates a method of producing refractory brick from a spent Claus catalyst.

### BACKGROUND

The conversion of hydrogen sulfide (H₂S) stripped from acid gas or refinery off-gas streams to elemental sulfur is known as the Claus process. The process consists of two-stages: the first process is thermal, and the second process is catalytic.

During the thermal process, the H₂S is partially oxidized with air, which is done in a reaction furnace at high temperatures (1,000° C.-1,400° C.). Sulfur is formed, but some H₂S remains unreacted, and some sulfur dioxide (SO₂) is also formed:

2H₂S+3O₂→2SO₂+2H₂O

During the catalytic process, the remaining H₂S is reacted with the SO₂ at lower temperatures (about 200° C.-350° C.) over a catalyst to make more sulfur:

2H₂S+SO₂→3Sₓ+2H₂O

The Claus catalyst, which offers improved sulfur conversion over spherical activated bauxite or alumina, has a high surface area, low density, and high macro-porosity. These properties provide maximum activity for the conversion of sulfur compounds. The production of Claus catalysts is described, for example, in U.S. Pat. No. 4,364,858. Even with the most efficient catalysts, the reaction does not run to completion. Therefore, two or three catalytic stages are typically required, with sulfur being removed between the stages.

Claus catalysts are deactivated due to the presence of accompanying hydrocarbons, particularly of C-5s and BTX (benzene, toluene, xylene), lay down of coke due to thermal cracking in the split-flow mode, and sulfur containing species, which result in lowering of sulfur recovery and polluting the atmosphere by releasing excessive amounts of SO₂ during acid gas flaring.

Hundreds of tons per year of spent Claus catalysts are produced by gas processing plants, gas oil separation plants and natural liquid gas fractionation facilities due to frequent replacement of alumina catalyst beds, and are considered waste materials. Therefore, there is a need for the utilization of the spent catalyst waste materials.

### SUMMARY

The disclosure provides a method of producing refractory brick. The method includes heating a spent Claus catalyst, reducing a particle size of the catalyst, dry mixing the catalyst with cement to form a dry mixture, adding water to the dry mixture to form a castable mixture, casting the castable mixture in a mold, curing the mold, and drying the mold to form the refractory brick.

### BRIEF DESCRIPTION OF THE FIGURES

FIG. 1 is a flow diagram for a method.

FIG. 2 is a chart of different types of monolithic refractory bricks (Types 1-11) based on their physical and chemical properties.

FIG. 3 depicts an image of refractory bricks synthesized in Examples 1A-E.

FIG. 4A is an XRD pattern of the refractory brick synthesized in Example 1A. The ICDD-PDF patterns for the identified compounds are given underneath the XRD pattern.

FIG. 4B is an XRD pattern of the refractory brick synthesized in Example 1B. The ICDD-PDF patterns for the identified compounds are given underneath the XRD pattern.

FIG. 4C is an XRD pattern of the refractory brick synthesized in Example 1C. The ICDD-PDF patterns for the identified compounds are given underneath the XRD pattern.

FIG. 4D is an XRD pattern of the refractory brick synthesized in Example 1D. The ICDD-PDF patterns for the identified compounds are given underneath the XRD pattern.

FIG. 4E is an XRD pattern of the refractory brick synthesized in Example 1E. The ICDD-PDF patterns for the identified compounds are given underneath the XRD pattern.

FIG. 5A is an ESEM image of the refractory brick synthesized in Example 1A.

FIG. 5B is an ESEM image of the refractory brick synthesized in Example 1B.

FIG. 5C is an ESEM image of the refractory brick synthesized in Example 1C.

FIG. 5D is an ESEM image of the refractory brick synthesized in Example 1D.

FIG. 5E is an ESEM image of the refractory brick synthesized in Example 1E.

FIG. 6 shows overlaid TGA thermograms of the refractory bricks synthesized in Examples 1A-1E.

FIG. 7A shows ESEM analysis of spent Claus catalysts.

FIG. 7B shows ESEM analysis of calcined spent Claus catalysts.

### DETAILED DESCRIPTION

Unless otherwise defined, all technical and scientific terms used in this document have the same meaning as commonly understood by one of ordinary skill in the art to which the present application belongs.

Provided herein is a method for producing refractory bricks that utilizes spent Claus catalyst. The disclosed methods can allow for better utilization of waste materials (e.g., spent catalyst balls) and reduce environmental pollution from landfilling.

Refractories are inorganic, nonmetallic, porous, and heterogeneous materials composed of thermally stable mineral aggregates, a binder phase, and additives. Since refractories are stable to alkaline slags and fumes at elevated temperatures, the refractory materials are used in linings for furnaces, kilns, incinerators and reactors. They are also used to make crucibles and molds for casting glass and metals and for surfacing flame deflector systems for rocket launch structures.

Oxides that can be used for manufacturing refractory bricks include SiO₂, Al₂O₃, TiO₂ and MgO. The conventional sources of these oxides are either pure or natural raw materials like silica sand, limestone, magnesite, clay, feldspar, granite, rutile, and nepheline syenite. The methods described herein utilize spent Claus catalysts, which contain high amounts of alumina (Al₂O₃), as an alternative source of alumina in the manufacturing of refractory bricks.

Provided herein is a method of producing refractory brick including: heating a spent Claus catalyst; reducing a particle size of the catalyst; dry mixing the catalyst with cement to form a dry mixture; adding water to the dry mixture to form a castable mixture; casting the castable mixture in a mold; curing the mold; and drying the mold to form the refractory brick.

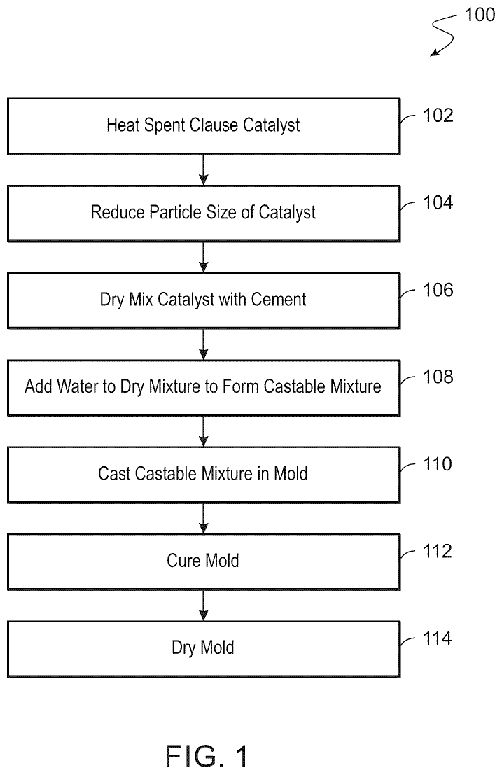

FIG. 1 depicts an example method 100 for producing refractory brick. In step 102, the spent Claus catalyst is heated. In step 104, the particle size of the catalyst is reduced. In step 106, the catalyst is dry mixed with cement, and optionally, aggregate. In step 108, water is added to the dry mixture to form a castable mixture. In step 110, the castable mixture is cast in a mold. In step 112, the mold is cured. In step 114, the mold is dried to form the refractory brick.

In some embodiments, the spent Claus catalysts are collected from gas plants. As used herein, a “spent catalyst” refers to a catalyst that does not recover its properties after treatment (e.g., a regeneration or rejuvenation process). For example, the spent catalyst does not recover one or more of surface area, pore volume, CCS, abrasion, and apparent bulk density (ABD).

In some embodiments, the heating step includes heating the spent Claus catalyst at a temperature in a range of about 400° C. to about 850° C. In some embodiments, the heating step includes heating the spent Claus catalyst at a temperature of about 400° C. to about 600° C., or about 500° C. In some embodiments, the spent Claus catalyst is heated for a time between about 1 hour and about 6 hours. In some embodiments, the heating time is selected based on the type and quantity of impurities in the spent catalyst. In some embodiments, heating the spent Claus catalyst calcines the catalyst.

In some embodiments, the reducing the particle size step includes reducing the particle size to a particle size of between about 0.01 mm and about 1 mm, between about 0.1 mm and about 0.5 mm, or between about 0.15 and about 0.425 mm.

In some embodiments, the reducing the particle size step includes crushing the catalyst and removing large particles using a sieve shaker. In some embodiments, the crushing is carried out for a crushing time of about 1 minutes to 10 minutes, 2 minutes to 6 minutes, or 3 minutes to 4 minutes. In some embodiments, the large particles have a particle size of greater than about 1 mm, greater than about 0.5 mm, or greater than about 0.425 mm.

In some embodiments, the crushing step includes crushing to a mesh size of at least one of 0.15 mm, 0.3 mm, and 0.425 mm. In some embodiments, the reducing the particle size step includes crushing the particles to a mesh size of 0.15 mm, 0.3 mm, and 0.425 mm. In some embodiments, the reducing the particle step size further includes mixing the 0.15 mm mesh particles, 0.3 mm mesh particles, and 0.425 mm mesh particles at a ratio of about 0.5:about 1:about 0.25.

In some embodiments, the dry mixing is carried out for about 1 second to about 1 hour, about 30 seconds to about 30 minutes, about 1 minute to about 10 minutes, or about 3 minutes to about 5 minutes.

In some embodiments, the dry mixture includes about 40 wt. % to about 80 wt. % of the catalyst. For example, the dry mixture includes about 50 wt. % to about 80 wt. %, or about 55 wt. % to about 75 wt. % of the catalyst.

Any suitable refractory cement that is capable of maintaining mechanical properties during prolonged exposure to high temperatures can be used in the dry mixture. In some embodiments, the cement comprises at least one of Portland cement, slag Portland cement, high-alumina cement, and periclase cement. In some embodiments, the dry mixture includes about 5 wt. % to about 45 wt. % of the cement. For example, the dry mixture includes about 10 wt. % to about 40 wt. %, about 15 wt. % to about 35 wt. %, about 20 wt. % to about 30 wt. %, or about 25 wt. % of the cement.

In some embodiments, the dry mixing includes mixing the catalyst with the cement and an aggregate to form the dry mixture. The term “aggregate,” as used herein, refers to a refractory material (e.g., crushed rock, stone, or sand and clay) for making monolithic refractory. Any suitable refractory aggregate can be used in the dry mixture. In some embodiments, the aggregate comprises at least one of clay refractory aggregate, high alumina refractory aggregate, corundum refractory aggregate, siliceous refractory aggregate, magnesia refractory aggregate, and magnesia alumina spinel refractory aggregate. In some embodiments, the aggregate is chosen based on temperature stability, mechanical strength, and corrosion resistance. In some embodiments, the type or quantity of aggregate can affect the properties of the refractory brick.

In some embodiments, the dry mixture includes about 0.1 wt. % to about 75 wt. % of the aggregate. For example, the dry mixture includes about 1 wt. % to about 50 wt. %, about 10 wt. % to about 45 wt. %, about 1 wt. % to about 25 wt. %, or about 5 wt. % to about 20 wt. % of the aggregate.

In some embodiments, the dry mixture includes about 50 wt. % to about 90 wt. % of the catalyst; about 10 wt. % to about 40 wt. % of the cement; and about 1 wt. % to about 45 wt. % of the aggregate.

In some embodiments, the dry mixture is essentially free of bauxite. In some embodiments, the dry mixture is essentially free of heavy metals. In some embodiments, the dry mixture is essentially free of a spent cracking catalyst or a zeolite-based catalyst.

In some embodiments, the castable mixture comprises about 1 wt. % to about 50 wt. %, about 10 wt. % to about 40 wt. %, or about 20 wt. % to about 35 wt. % water. In some embodiments, the water is deionized water. In some embodiments, the castable mixture is prepared by wet mixing for a wet mixing time of about 1 second to about 1 hour, about 30 seconds to about 30 minutes, about 1 minute to about 10 minutes, or about 3 minutes to about 5 minutes. In some embodiments, the wet mixing is carried out at an ambient temperature. The amount of water in the castable mixture can be optimized to avoid shrinking or cracking of the refractory brick. In some embodiments, excessive cracking indicates that too much water was used in the castable mixture.

In some embodiments, the mold is a cast iron mold. In some embodiments, the mold is a 100 mm×100 mm×100 mm cast iron mold.

In some embodiments, the mold is cured at a curing temperature in a range between about 70° C. to about 150° C. In some embodiments, the mold is cured at a curing temperature of about 110° C. In some embodiments, the mold is cured for a curing time of about 12 hours to about 24 hours. In some embodiments, the mold is cured for a curing time of about 18 hours.

In some embodiments, the mold is dried at a drying temperature in a range of about 600° C. to about 1000° C. In some embodiments, the mold is dried at a drying temperature of about 815° C. In some embodiments, the mold is dried for a drying time in a range between about 2 hours and about 24 hours. In some embodiments, the mold is dried for a drying time of about 11 hours.

In some embodiments, the spent Claus catalyst includes about 70 wt. % to about 90 wt. % alumina. For example, the spent Claus catalyst includes about 70 wt. % to about 85 wt. %, or about 74 wt. % to about 84 wt. % alumina. The alumina content of the spent Claus catalyst can be measured by X-ray fluorescence spectroscopy.

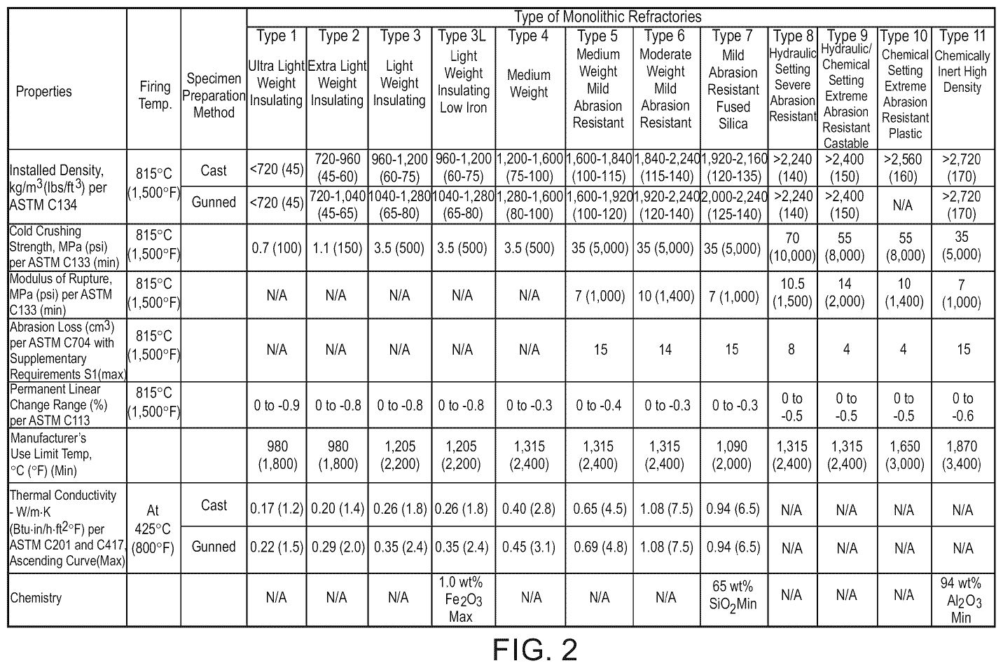

FIG. 2 shows different types of monolithic refractory bricks (Types 1-11) based on their physical and chemical properties. In some embodiments, the refractory brick has properties in accordance with the specifications of one of Type 1 through Type 11 as shown in FIG. 2.

In some embodiments, the refractory brick has a cold crushing strength (CCS) in a range of about 50 PSI to about 10,000 PSI, about 100 PSI to about 7500 PSI, about 500 PSI to about 5000 PSI, about 1000 PSI to about 4000 PSI, or about 1200 PSI to about 3800 PSI. In some embodiments, a ratio of Al₂O₃ to aggregate in the dry mixture is adjusted to optimize the cold crush strength. The CCS of the refractory brick can be determined by ASTM method C133.

In some embodiments, the refractory brick comprises at least about 50 wt. % corundum (Al₂O₃). In some embodiments, the refractory brick comprises rutile (TiO₂). In some embodiments, the refractory brick comprises about 55 wt. % to about 95 wt. % corundum and about 1 wt. % to about 35 wt. % rutile. In some embodiments, the refractory brick comprises corundum, rutile, hematite (Fe₂O₃), calcium aluminum oxide (e.g., Ca₁₂Al₁₄O₃₂), quartz (SiO₂), calcium silicate (Ca₂SiO₄), anhydrite (CaSO₄), aragonite (CaCO₃), or a combination thereof. The chemical composition of the refractory brick can be determined by powder X-ray diffraction.

In some embodiments, the method further includes removing a spent Claus catalyst from a reactor. The spent Claus catalysts can be removed from the reactor in several steps. In an example method, catalyst converters are taken out of service by closing the isolation valves following adsorbent regeneration and de-pressuring steps. The converters are purged with nitrogen and insulation and manhole covers are removed. Various energy sources (e.g., electrical, mechanical, pneumatic, chemical feed lines, etc.), are removed before personnel are permitted to enter the converters. Instrumentation (e.g., thermocouples and thermos-wells) can be removed to prevent damage to them. Chalk catalyst level lines on the wall can be used to assist workers when leveling the bed. The alumina catalyst can be removed with depth of 30 mm in the immediate vicinity of the manway working down to the bottom of the bed. The removal can be carried out toward the opposite side of the converter. The 6″ SS wires mesh (0.063″ diameter) located in the middle section of catalyst converter can be removed. The titanium catalyst with depth of 15 mm can be taken out. Two ceramic supports (¼ in and ½ in) in the bottom of converters can be removed. As the temporary storage containers for the catalyst fill, the containers can be removed and stored in a dry area protected from the elements. Once the catalysts are completely removed, the catalyst support SS wire mesh can be cleaned. The bed separation plate located below the catalyst bed can also be cleaned. An inspection of the converter can be performed and any repairs can be initiated as required.

Catalyst screening can be performed on ceramic balls to install ¼ on the top of the catalysts bed and ½ on the bottom of the catalyst bed. Catalyst from each layer and bed can be kept sperate from each other. Catalyst samples can be taken to be analyzed for activity. If the spent catalysts are deactivated, they are typically collected and dumped in landfills.

The methods provided herein can allow for an eco-friendly and cost-effective use for spent Claus catalysts as an alternative to their disposal in landfills. The refractory bricks produced form the methods described herein can have applications as linings for furnaces to minimize heat loss through the furnace walls. The refractory bricks can also have applications in kilns, incinerators, and reactors.

As used in this disclosure, the term “about” can allow for a degree of variability in a value or range, for example, within 10%, within 5%, or within 1% of a stated value or of a stated limit of a range.

As used in this disclosure, the term “essentially free” can refer to less than 5 wt. %, less than 1 wt. %, less than 0.01 wt. %, or less than 0.001 wt. %.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited.

Particular embodiments of the subject matter have been described. Other implementations, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

### EXAMPLES

### Characterization

All the processes were done according to ASTM standard procedures and Guidelines from API 936 and SAES-N-110.

### Bulk Density

Bulk Density is the mass of a unit volume of a substance. It is usually expressed either in kilogram per cubic meter, grams per cubic centimeter, or pounds per cubic foot. Specimen were prepared in a 50 mm*50 mm*50 mm cube mold and measured using a digital Vernier Caliper (VC) (to the nearest 0.002 lb (1.0 g)).

The specimen was dried in an oven for 18 hrs. at 110° C. The resulting specimen was physically tested and data was recorded to the nearest 0.002 lb. (1.0 g). The resulting specimen was heated at 815° C. for 11 hrs. and physically tested. All physical data including density were recorded at room temperature, 110° C., and 815° C.

### Cold Crushing Strength (CCS)

Cold crushing strength is a measure of a refractory's ability to resist failure under a compressive load at room temperature after drying and/or firing. The cooked sample was crushed by a digital CCS machine, and the load applied and strength were recorded.

CCS is calculated by dividing the total compressive load by the specimen cross-sectional area:

S=W/A

wherein S=Cold crushing strength in (Mpa); W=Total maximum load indicated by testing machine (N); A-Average of the areas of the top and bottom of the specimen perpendicular to the line of application of the load in (mm²).

### Dimensional Test

The dimensional test covers the size measurement of refractory brick. Resulted refractory bricks were measured according to the ASTM C1113 standard. Length and Width-Measure the length and width of each of the specimens across the middle of each of the faces of the largest area to the nearest 0.5 mm.

### X-Ray Powder Diffraction

X-Ray powder diffraction was used to determine the chemical composition of refractory samples. The samples were analyzed using Ultima IV X-Ray powder Diffraction system. The Standard Operating Procedure (SOP 183) was used for XRD analysis. The data was collected with 1 second integral time on Copper-anode tube operated at 40 kV and 40 mA. The crystalline compounds were identified by the High Score+program and the semi quantification of data achieved by a Rietveld refinement method.

### Environmental Scanning Electron Microscopy (ESEM)

A small piece of each brick was put on a double-sided carbon tape affixed on an aluminum stub. The sample was cleaned using air (EasyDuster) and then inserted into the ESEM sample chamber. The ESEM was operated at 20 kV, and 10-12 mm working distance. The images were taken using a Backscattered Electron detector and Secondary Electron Detector.

### Thermogravimetric Analysis (TGA)

The bricks were analyzed using TGA Q500 (TA). The analyses were carried out from ambient temperature to 900° C. at a heating rate of 20° C./min under air atmospheres to determine the weight losses and residual masses.

### Example 1A-E: Refractory Brick Syntheses

For each of examples 1A-E, spent Claus catalyst recovered from a gas plant was heated at 500° C. for 6 hours. The spent catalyst was crushed for 3-4 minutes to mesh sizes 0.15 mm, 0.3 mm, and 0.425 mm, and large particles were removed using a sieve shaker. The spent catalyst was dry mixed with unbound aggregates (A4) and Portland cement for 3-5 minutes to form a dry mixture. Water (about 350 mL) was added, and wet mixing was carried out for 3-5 minutes. The resulting wet mixture was cast in a cast iron mold for about 15-20 minutes. The castable mold was cured for 24 hours, and then dried at 110° C. for 18 Hrs. The castable mold was heated at 815° C. for 11 Hrs. Table 1 shows the composition of materials used for the dry mixture of the refractory brick syntheses of Examples 1A-E.

TABLE 1
Wt. % of the materials used for the dry
mixture of the refractory brick syntheses

| | Catalyst | Cement | Aggregate (A4) |
|---|---|---|---|
| Example | (Wt. %) | (Wt. %) | (Wt. %) |
| 1A | 75 | 25 | 0 |
| 1B | 70 | 25 | 5 |
| 1C | 65 | 25 | 10 |
| 1D | 60 | 25 | 15 |
| 1E | 55 | 25 | 20 |

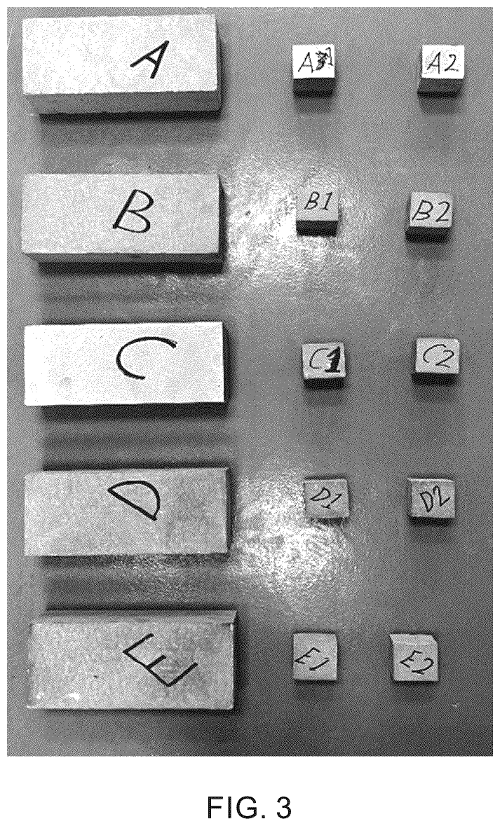

FIG. 3 shows a visual representation of refractory bricks synthesized from Examples 1A-E.

### Example 2: Crush Strength Analysis of Synthesized Refractory Bricks

Cold crushing strength (CCS) results were evaluated against SAES-N-100. Tables 2-6 show characteristics of three samples of each of Examples 1 A-E.

TABLE 2
Example 1A

| | | | | | | Bulk | | | |
|---|---|---|---|---|---|---|---|---|---|
| | | | | | | Density | | | Cold Crushing |
| | Size of samples | | | | | (ASTM | | | Strength |
| | (M) | | | Volume | Weight | C134) | Load | Area | (ASTM C133) |
| Sample | L | B | H | (M³) | (g) | [Kg/m3] | (KN) | (M2) | [Mpa] |
| 1A-1 | 0.05 | 0.05 | 0.05 | 125×⁻³ | 182.27 | 1458.1600 | 22.834 | 0.00250 | 9.1 |
| 1A-2 | 0.05 | 0.05 | 0.05 | 125×⁻³ | 183.44 | 1467.5200 | 20.416 | 0.00250 | 8.2 |
| 1A-3 | 0.05 | 0.05 | 0.05 | 125×⁻³ | 182.4 | 1459.2000 | 20.489 | 0.00250 | 8.2 |
| | | | | | | Average | | | Average |
| | | | | | | 1461.6267 | | | 8.5 (1233 PSI) |

TABLE 3
Example 1B

| | Size of samples | | | | | Bulk | | | Cold Crushing |
|---|---|---|---|---|---|---|---|---|---|
| | (M) | | | Volume | Weight | Density | Load | Area | Strength |
| Sample | L | B | H | (M³) | (Kg) | [Kg/m3] | (KN) | (M2) | [Mpa] |
| 1B-1 | 0.05 | 0.05 | 0.05 | 0.0001250 | 0.18948 | 1515.8400 | 31.315 | 0.00250 | 12.5 |
| 1B-2 | 0.05 | 0.05 | 0.05 | 0.0001250 | 0.18942 | 1515.3600 | 32.561 | 0.00250 | 13.0 |
| 1B-3 | 0.05 | 0.05 | 0.05 | 0.0001250 | 0.18903 | 1512.2400 | 31.08 | 0.00250 | 12.4 |
| | | | | | | Average | | | Average |
| | | | | | | 1514.4800 | | | 12.7 (1842 PSI) |

TABLE 4
Example 1C

| | Size of samples | | | | | Bulk | | | Cold Crushing |
|---|---|---|---|---|---|---|---|---|---|
| | (M) | | | Volume | Weight | Density | Load | Area | Strength |
| Sample | L | B | H | (M³) | (Kg) | [Kg/m3] | (KN) | (M2) | [Mpa] |
| 1C-1 | 0.05 | 0.05 | 0.05 | 0.0001250 | 0.2218 | 1774.4000 | 46.334 | 0.00250 | 18.5 |
| 1C-2 | 0.05 | 0.05 | 0.05 | 0.0001250 | 0.22712 | 1816.9600 | 50.644 | 0.00250 | 20.3 |
| 1C-3 | 0.05 | 0.05 | 0.05 | 0.0001250 | 0.22988 | 1839.0400 | 49.833 | 0.00250 | 19.9 |
| | | | | | | Average | | | Average |
| | | | | | | 1810.1333 | | | 19.6 (2843 PSI) |

TABLE 5
Example 1D

| | Size of samples | | | | | Bulk | | | Cold Crushing |
|---|---|---|---|---|---|---|---|---|---|
| | (M) | | | Volume | Weight | Density | Load | Area | Strength |
| Sample | L | B | H | (M³) | (Kg) | [Kg/m3] | (KN) | (M²) | [Mpa] |
| 1D-1 | 0.05 | 0.05 | 0.05 | 0.0001250 | 0.23369 | 1869.5200 | 59.672 | 0.00250 | 23.9 |
| 1D-2 | 0.05 | 0.05 | 0.05 | 0.0001250 | 0.23465 | 1877.2000 | 62.78 | 0.00250 | 25.1 |
| 1D-3 | 0.05 | 0.05 | 0.05 | 0.0001250 | 0.23591 | 1887.2800 | 64.571 | 0.00250 | 25.8 |
| | | | | | | Average | | | Average |
| | | | | | | 1878.0000 | | | 24.9 (3611 PSI) |

TABLE 6
Example 1E

| | Size of samples | | | | | Bulk | | | Cold Crushing |
|---|---|---|---|---|---|---|---|---|---|
| | (M) | | | Volume | Weight | Density | Load | Area | Strength |
| Sample | L | B | H | (M³) | (Kg) | [Kg/m³] | (KN) | (M²) | [Mpa] |
| 1E-1 | 0.05 | 0.05 | 0.05 | 125 × 10⁻³ | 0.22249 | 1779.9200 | 59.302 | 0.00250 | 23.7 |
| 1E-2 | 0.05 | 0.05 | 0.05 | 125 × 10⁻³ | 0.22478 | 1798.2400 | 66.231 | 0.00250 | 26.5 |
| 1E-3 | 0.05 | 0.05 | 0.05 | 125 × 10⁻³ | 0.22389 | 1791.1200 | 70.881 | 0.00250 | 28.4 |
| | | | | | | Average | | | Average |
| | | | | | | 1789.7600 | | | 26.2 (3800 PSI) |

Crush strength results of the synthesized refractory bricks were compared with commercial refractory bricks. The refractory bricks of Examples 1A-E showed a higher CCS value than some of the commercial bricks as indicated in Table 7.

TABLE 7
Crush strength compression of refractory bricks of examples 1A-E
with commercial products available in the Saudi Arabia market

| Sample | | Crush Strength |
|---|---|---|
| No. | Refractory Brick | (PSI) |
| 1 | Example 1A | 1233 |
| 2 | Example 1B | 1842 |
| 3 | Example 1C | 2843 |
| 4 | Example 1D | 3611 |
| 5 | Example 1E | 3800 |
| 6 | SRI Refractory 101 AL = 82% | 6,316 |
| 7 | AL-FARAN 1 | 5,623 |
| 8 | Kareena-Sabic Goudah 9500 | 5,338 |
| 9 | Kareena-Sabic Goudah | 3,506 |
| 10 | AL-FARAN CAST 94 Refractory Castable | 3,277 |
| 11 | AL-FARAN LITE 7-11 Refractory Castable | 823 |
| 12 | AL-FARAN 2 | 206 |
| 13 | AL-FRAN LITE 10-14 Refractory | 67 |

### Example 3: X-Ray Powder Diffraction Analysis of Synthesized Refractory Bricks

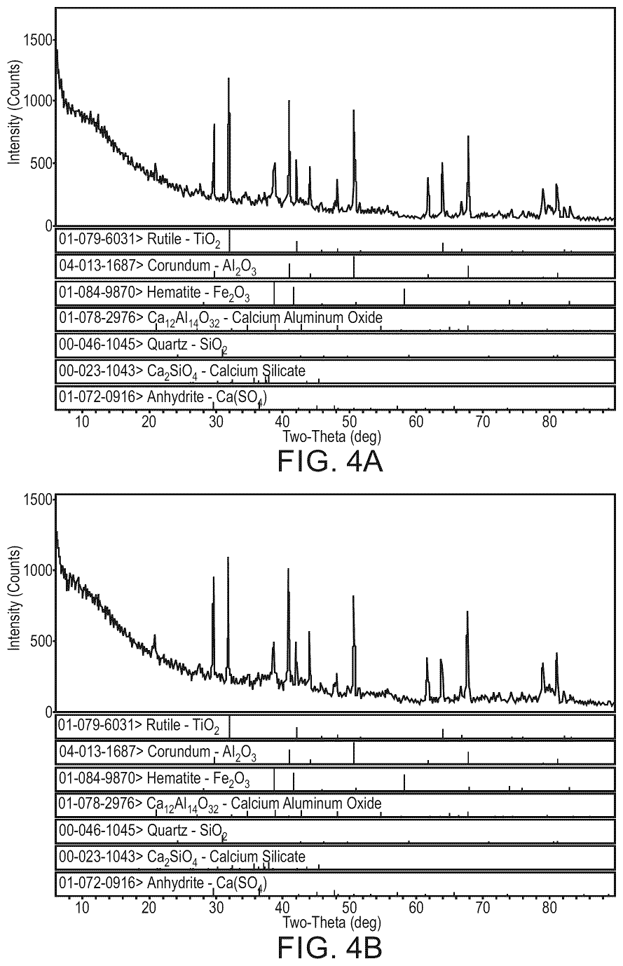

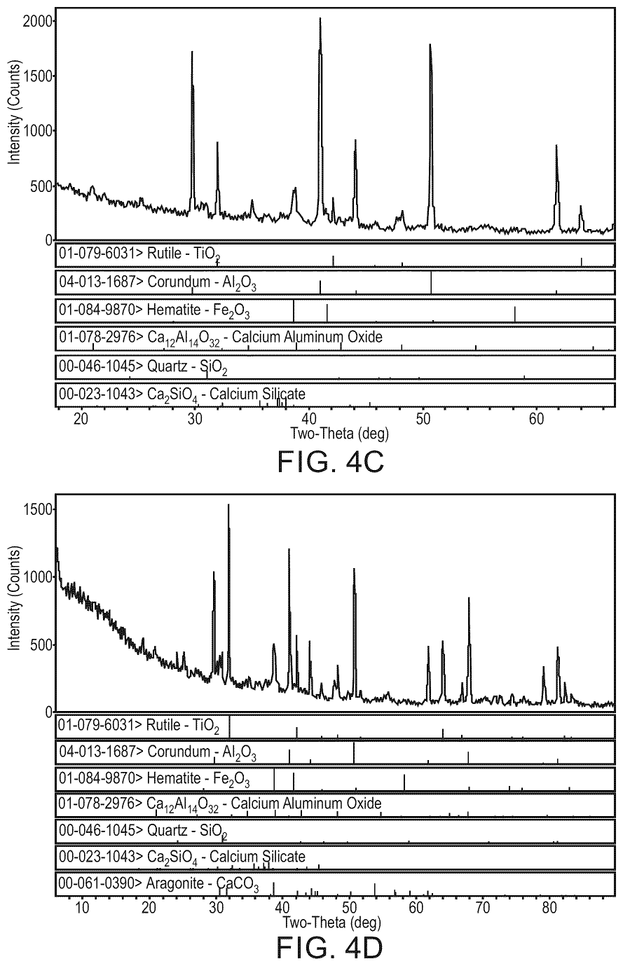

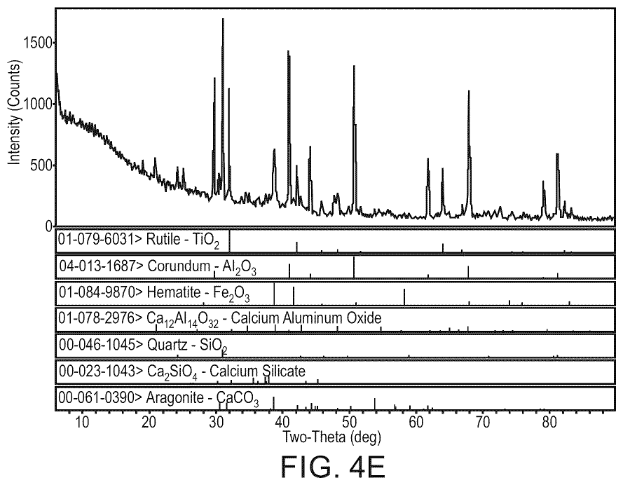

X-ray powder diffraction was used to determine the chemical composition of refractory samples. The crystalline compounds were identified by the High Score+program and the semi quantification of data was calculated using a Rietveld refinement method, as shown in FIGS. 4A-E. The XRD results indicate that the in-house synthesized refractory bricks consisted mainly of Corundum-Al₂O₃ and Rutile-TiO₂. Other trace phases are observed in the bricks.

The identified crystalline compounds with approximate weight percentages are listed in Table 8.

TABLE 8
Weight percentages of the identified crystallin compounds

| Example | 1A | 1B | 1C | 1D | 1E |
|---|---|---|---|---|---|
| Corundum-Al₂O₃ | 65 | 72 | 86 | 67 | 66 |
| Rutile-TiO₂ | 25 | 21 | 7 | 25 | 13 |
| Calcium Aluminum Oxide- | 5 | 3 | 3 | 2 | 5 |
| Ca₁₂Al14O₃₂ | | | | | |
| Calcium Silicate- Ca₂SiO₄ | 2 | 1 | 1 | 1 | 1 |
| Hematite-Fe₂O₃ | 1 | 2 | 2 | 1 | 1 |
| Anhydrite-CaSO₄ | 1 | 1 | — | — | — |
| Quartz-SiO₂ | 1 | 1 | 1 | 3 | 13 |
| Aragonite- CaCO₃ | — | — | — | 1 | 1 |

### Example 4: ESEM Analysis of Synthesized Refractory Bricks

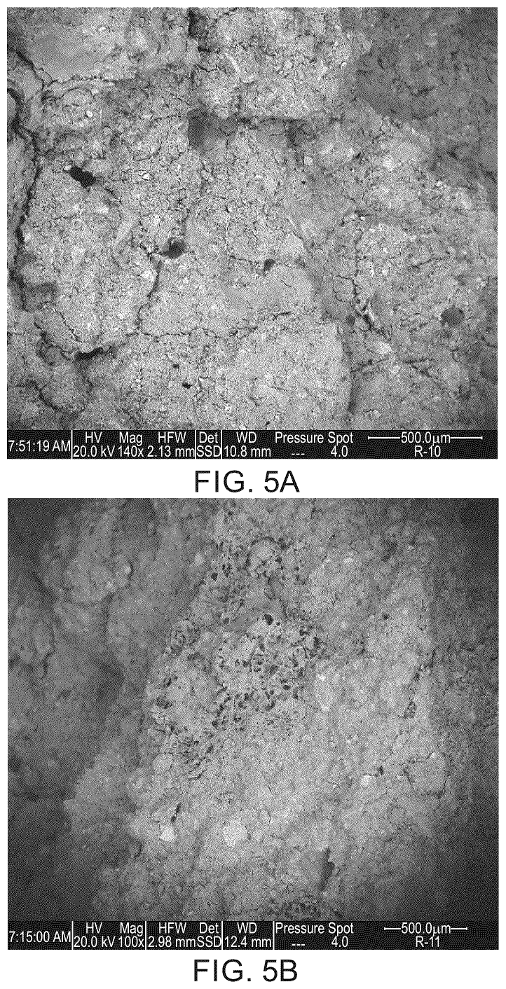

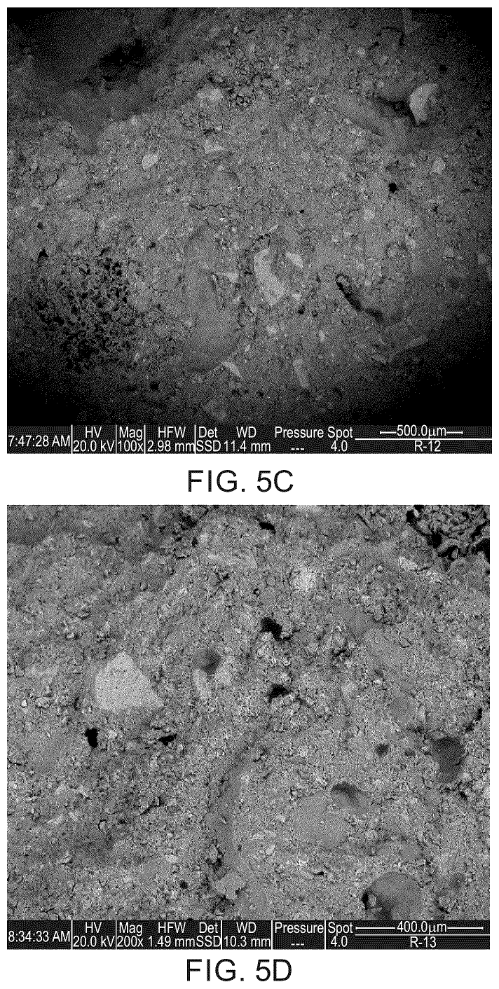

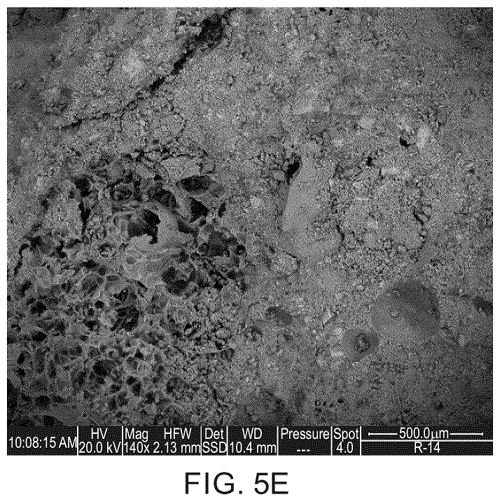

ESEM was utilized to study the morphology, distribution of catalyst in the synthesized refractory materials, and their particle sizes in the refractory bricks as illustrated in FIGS. 5A-E. The collected images showed that the obtained bricks were well homogenized and the spent catalyst balls were very well distributed among the final bricks.

### Example 5: Thermal Analysis of Synthesized Refractory Bricks

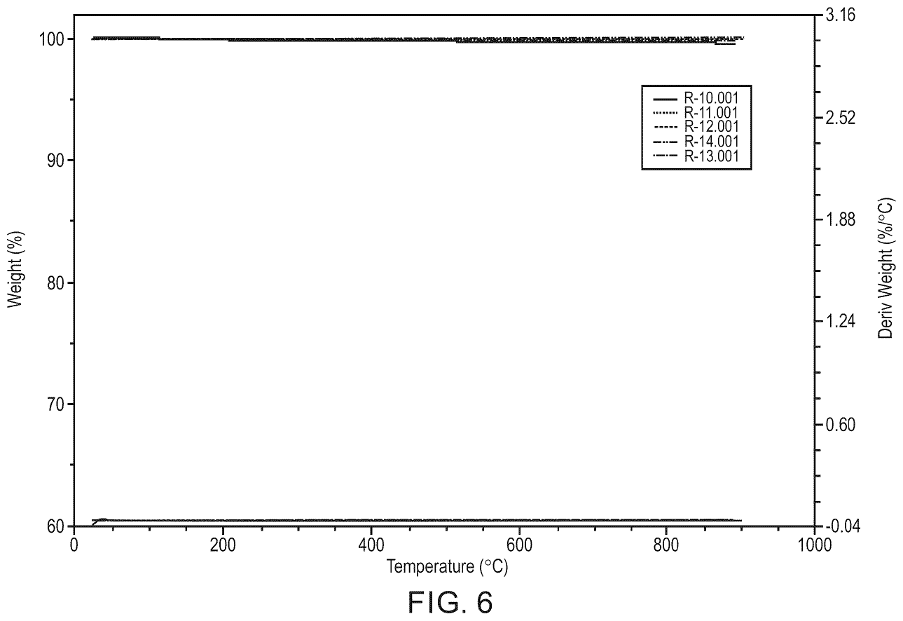

Thermal behavior of different refractory bricks was investigated. The TGA was programmed to heat the samples from ambient temperature to 900° C. at a rate of 20° C./min. The TGA data indicates that the bricks are stable up to 900° C., as shown in FIGS. 6A-E.

### Example 6: Variation in Refractory Brick Synthesis Conditions

It was found that if the spent Claus catalysts are contaminated with coke (carbon), treating thermally at a temperature of 500-850° C. for several hours can remove impurities that might compromise the refractory brick's properties, such as being weak and easy to break.

In some examples, the cold crush strength was found to depend on a ratio of Al₂O₃ to aggregate ratio. In some examples, selecting an aggregate amount of about 10 to 45 wt. % resulted in very rigid bricks.

In some examples, water type and ratio can affect the produced refractory. For example, the dry mixture was mixed with deionized water at a ratio of 20-35 wt. % at room temperature and the water was removed in a slow and controlled manner to avoid shrinking/cracking.

### Example 7: Analysis of Spent Claus Catalyst Samples 1-4

Four samples of spent Claus catalyst from different petroleum processing plants and processes were analyzed utilizing X-ray fluorescence spectrometry. The catalysts were presumed to be from different batches and may have been from different commercial producers. Each of the samples was ground in an agate pestle to a fineness of about 100 mesh and mixed thoroughly before being exposed to the X-ray beam. These samples were composed mainly of aluminum, carbon, sulfur, hydrocarbon and traces of other metals. Sample 1 contained higher aluminum oxide content and less carbon and hydrocarbon components when compared to other spent catalyst samples. The alumina content of the samples ranged from about 74% to 84% by weight, as shown in Table 9. In Table 9, “L.O.I” refers to loss of ignition (total weight loss at 950° C.).

TABLE 9
Composition (wt. %) of four spent Claus catalysts as received

| | Sample 1 | Sample 2 | Sample 3 | Sample 4 |
|---|---|---|---|---|
| Compound | Wt. % | Wt. % | Wt. % | Wt. % |
| SiO₂ | <0.01 | <0.01 | <0.01 | <0.01 |
| Al₂O₃ | 83.74 | 74.84 | 75.31 | 74.35 |
| Fe₂O₃ | <0.01 | <0.01 | <0.01 | <0.01 |
| CaO | 0.09 | 0.08 | 0.0 | 0.08 |
| MgO | 0.23 | 0.20 | 0.20 | 0.20 |
| SO₃ | 0.09 | 0.27 | 0.29 | 0.20 |
| Na₂O | 0.28 | 0.25 | 0.26 | 0.25 |
| K₂O | <0.01 | <0.01 | <0.01 | <0.01 |
| TiO₂ | <0.01 | <0.01 | <0.01 | <0.01 |
| P₂O₅ | <0.01 | <0.01 | <0.01 | <0.01 |
| Mn₂O₃ | <0.01 | <0.01 | <0.01 | <0.01 |
| SrO | 0.02 | 0.02 | 0.02 | 0.02 |
| Cr₂O₃ | <0.01 | <0.01 | <0.01 | <0.01 |
| ZnO | 0.01 | 0.01 | 0.01 | 0.01 |
| L.O.I. (950° C.) | 15.54 | 23.99 | 23.61 | 24.44 |

### Example 8: Regeneration and Rejuvenation of Spent Claus Catalyst Samples

The physical and chemical properties of spent Claus catalysts have also been investigated by regeneration and rejuvenation the spent Claus catalysts. The regeneration was carried out by burning off all contaminates from the outer surface of spent catalyst samples collected from different plants. The rejuvenation was carried out using malonic acid. The results showed both regeneration and rejuvenation processes did not recover the physical and chemical properties of the spent catalyst samples, as shown in Table 10.

TABLE 10
Compression of fresh, deactivated, regenerated,
and rejuvenated catalyst samples

| | Sample | Sample | Sample | Sample | Sample | Sample |
|---|---|---|---|---|---|---|
| Properties | A | B | C | D | E | F |
| Surface Area, | 369 | 195 | 197 | 208 | 210 | 280 |
| m²/g | | | | | | |
| Pore Vol, ml/g | 0.41 | 0.29 | 0.13 | 0.32 | 0.35 | 0.38 |
| Av. Pore Dia. | 44.0 | 59.3 | 63.9 | 59.7 | 61.3 | 60.3 |
| A | | | | | | |
| Crush Strength, | 189 | 146 | 112 | 117 | 132 | 160 |
| N/mm | | | | | | |
| ABD, Kg/m³ | 628 | 616 | 609 | 666 | 652 | 670 |
| Abs, Density, | 3.84 | 3.17 | 3.19 | 3.35 | 3.26 | 3.32 |
| g/ml | | | | | | |

Sample A was a fresh Claus catalyst. Sample B was a spent Claus catalyst. Sample C was a regenerated spent Claus catalyst. Sample D was a spent Claus catalyst leached with oxalic acid. Sample E was a spent Claus catalyst leached with malonic acid. Sample F was a spent Claus catalyst leached with malonic acid and aluminum nitrate.

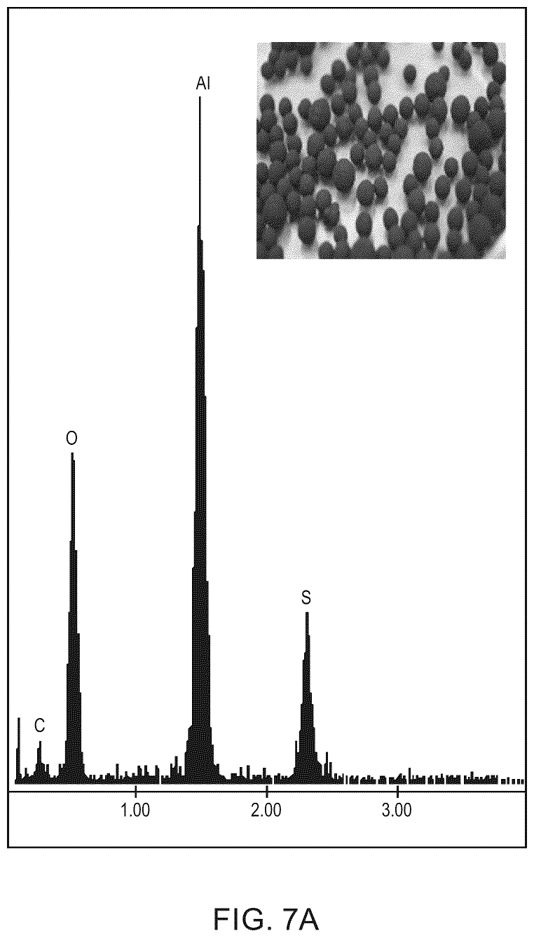

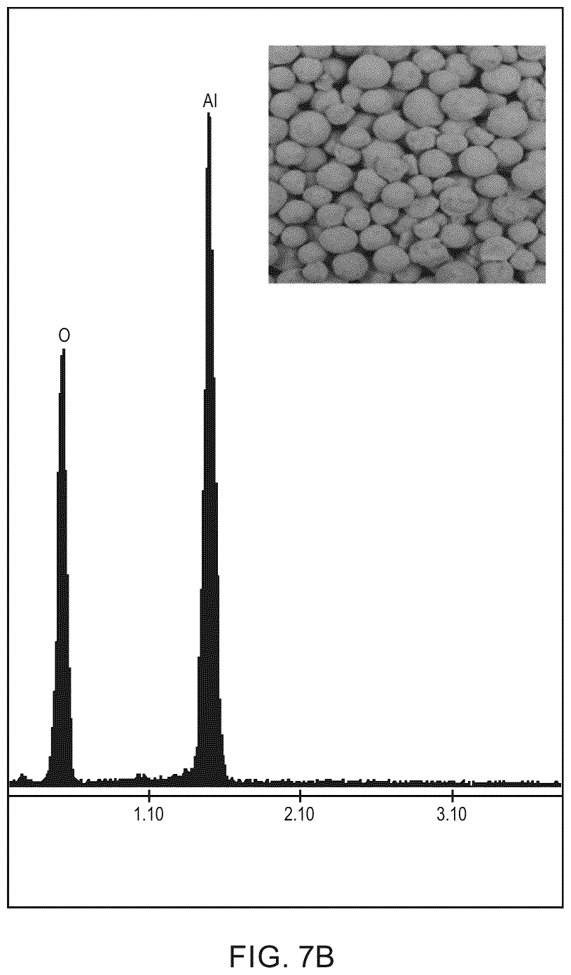

The spent Claus catalysts were also evaluated by ESEM to determine the catalysts' potential for reuse or recycling. FIG. 7A shows an image and ESEM analysis of spent catalysts, and FIG. 7B shows an image and ESEM analysis of the calcined catalysts.

### Exemplary Embodiments

1) A method of producing refractory brick comprising:
heating a spent Claus catalyst;
reducing a particle size of the catalyst;
dry mixing the catalyst with cement to form a dry mixture;
adding water to the dry mixture to form a castable mixture;
casting the castable mixture in a mold;
curing the mold; and
drying the mold to form the refractory brick.
2) The method of Embodiment 1, wherein the heating step comprises heating the spent Claus catalyst at a temperature in a range of about 400° C. to about 850° C.
3) The method of Embodiment 1 or 2, wherein the spent Claus catalyst is heated for a time between about 1 hour and about 6 hours.
4) The method of any one of Embodiments 1-3, wherein the reducing the particle size step comprises reducing to a particle size of between about 0.1 mm and about 0.5 mm.
5) The method of any one of Embodiments 1-4, wherein the reducing the particle size step comprises crushing the catalyst.
6) The method of Embodiment 5, wherein the crushing step comprises crushing to a mesh size of at least one of 0.15 mm, 0.3 mm, and 0.425 mm.
7) The method of any one of Embodiments 1-6, wherein the reducing the particle size step comprises:
crushing the particles to a mesh size of 0.15 mm, 0.3 mm, and 0.425 mm; and
mixing the 0.15 mm mesh particles, 0.3 mm mesh particles, and 0.425 mm mesh particles at a ratio of about 0.5:about 1:about 0.25.
8) The method of any one of Embodiments 1-7, wherein the dry mixture further comprises mixing the catalyst and the cement with an aggregate.
9) The method of Embodiment 8, wherein the dry mixture comprises:
about 50 wt. % to about 90 wt. % of the catalyst;
about 10 wt. % to about 40 wt. % of the cement; and about 1 wt. % to about 45 wt. % of the aggregate.
10) The method of Embodiment 8 or 9, wherein the aggregate comprises at least one of clay refractory aggregate, high alumina refractory aggregate, corundum refractory aggregate, siliceous refractory aggregate, magnesia refractory aggregate, and magnesia alumina spinel refractory aggregate.
11) The method of any one of Embodiments 1-10, wherein the cement comprises at least one of Portland cement, slag Portland cement, high-alumina cement, and periclase cement.
12) The method of any one of Embodiments 1-11, wherein the castable mixture comprises about 20 wt. % to about 35 wt. % water.
13) The method of any one of Embodiments 1-12, wherein the mold is cured at a curing temperature in a range between about 70° C. to about 150° C.
14) The method of any one of Embodiments 1-13, wherein the mold is cured for a curing time of about 12 hours to about 24 hours.
15) The method of any one of Embodiments 1-14, wherein the mold is dried at a drying temperature in a range of about 600° C. to about 1000° C.
16) The method of any one of Embodiments 1-15, wherein the mold is dried for a drying time in a range between about 2 hours and about 24 hours.
17) The method of any one of Embodiments 1-16, wherein the spent Claus catalyst comprises about 70 wt. % to about 90 wt. % alumina.
18) The method of any one of Embodiments 1-17, wherein the refractory brick has a cold crushing strength in a range of about 1000 PSI to about 4000 PSI.
19) The method of any one of Embodiments 1-19, wherein the refractory brick comprises about 55 wt. % to about 95 wt. % corundum and about 1 wt. % to about 35 wt. % rutile.
20) The method of any one of Embodiments 1-19, further comprising removing the spent Claus catalyst from a reactor.

Other implementations are also within the scope of the following claims.

What is claimed is:

1. A method of producing refractory brick comprising:
heating a spent Claus catalyst;
reducing a particle size of the catalyst;
dry mixing the catalyst with cement to form a dry mixture;
adding water to the dry mixture to form a castable mixture;
casting the castable mixture in a mold;
curing the mold; and
drying the mold to form the refractory brick.

2. The method of claim 1, wherein the heating step comprises heating the spent Claus catalyst at a temperature in a range of about 400° C. to about 850° C.

3. The method of claim 2, wherein the spent Claus catalyst is heated for a time between about 1 hour and about 6 hours.

4. The method of claim 1, wherein the reducing the particle size step comprises reducing to a particle size of between about 0.1 mm and about 0.5 mm.

5. The method of claim 1, wherein the reducing the particle size step comprises crushing the catalyst.

6. The method of claim 5, wherein the crushing step comprises crushing to a mesh size of at least one of 0.15 mm, 0.3 mm, and 0.425 mm.

7. The method of claim 6, wherein the reducing the particle size step comprises:
crushing the particles to a mesh size of 0.15 mm, 0.3 mm, and 0.425 mm; and
mixing the 0.15 mm mesh particles, 0.3 mm mesh particles, and 0.425 mm mesh particles at a ratio of about 0.5:about 1:about 0.25.

8. The method of claim 1, wherein the dry mixture further comprises mixing the catalyst and the cement with an aggregate.

9. The method of claim 8, wherein the dry mixture comprises:
about 50 wt. % to about 90 wt. % of the catalyst;
about 10 wt. % to about 40 wt. % of the cement; and
about 1 wt. % to about 45 wt. % of the aggregate.

10. The method of claim 8, wherein the aggregate comprises at least one of clay refractory aggregate, high alumina refractory aggregate, corundum refractory aggregate, siliceous refractory aggregate, magnesia refractory aggregate, and magnesia alumina spinel refractory aggregate.

11. The method of claim 1, wherein the cement comprises at least one of Portland cement, slag Portland cement, high-alumina cement, and periclase cement.

12. The method of claim 1, wherein the castable mixture comprises about 20 wt. % to about 35 wt. % water.

13. The method of claim 1, wherein the mold is cured at a curing temperature in a range between about 70° C. to about 150° C.

14. The method of claim 1, wherein the mold is cured for a curing time of about 12 hours to about 24 hours.

15. The method of claim 1, wherein the mold is dried at a drying temperature in a range of about 600° C. to about 1000° C.

16. The method of claim 1, wherein the mold is dried for a drying time in a range between about 2 hours and about 24 hours.

17. The method of claim 1, wherein the spent Claus catalyst comprises about 70 wt. % to about 90 wt. % alumina.

18. The method of claim 1, wherein the refractory brick has a cold crushing strength in a range of about 1000 PSI to about 4000 PSI.

19. The method of claim 1, wherein the refractory brick comprises about 55 wt. % to about 95 wt. % corundum and about 1 wt. % to about 35 wt. % rutile.

20. The method of claim 1, further comprising removing the spent Claus catalyst from a reactor.
